(19) United States
(12) Patent Application Publication
(10) Pub. No.: US 2017/0032404 A1
(43) Pub. Date: Feb. 2, 2017

(54) Customer Purchase Data Network System, Method, and Apparatus

(71) Applicant: ShopFish, LLC, Pittsburgh, PA (US)

(72) Inventors: Matthew J. Sembrat, Pittsburgh, PA (US); Adam W. Sembrat, Carrollton, TX (US)

(21) Appl. No.: 15/223,560

(22) Filed: Jul. 29, 2016

Related U.S. Application Data
(60) Provisional application No. 62/199,077, filed on Jul. 30, 2015.

(51) Int. Cl. G06Q 30/02; G06Q 50/00; G06Q 20/12; G06F 17/30

(52) U.S. Cl. CPC G06Q 30/0214; G06F 17/30598; G06Q 50/01; G06Q 20/12; G06Q 30/0236; G06Q 30/0239

(57) ABSTRACT

Disclosed is a computer-implemented method, system, and apparatus for sharing user purchase data. The method includes receiving, from a user, a unique identifier associated with a user profile of the user; retrieving the user profile from at least one user database based on the unique identifier; retrieving, from at least one product database, purchase data for at least one item purchased by the user through at least one retailer; storing the purchase data in the at least one user database and associating the purchase data with the user profile; communicating, to a client device of the user, display data configured to generate at least one user interface on the client device includes a visual representation of at least a portion of the purchase data; and posting the at least a portion of the purchase data and at least one photograph or video to at least one social media platform.

### CROSS REFERENCE TO RELATED APPLICATION

This application claims priority to U.S. Provisional Patent Application No. 62/199,077 filed Jul. 30, 2015, and entitled “Customer Purchase Data Network System and Method,” the disclosure of which is hereby incorporated in its entirety by reference.

### BACKGROUND OF THE INVENTION

Field of the Invention

This invention relates generally to customer purchase data and, more specifically, to a system, method, and computer program product for sharing customer purchase data in social media networks.

Description of Related Art

The average U.S. consumer spends $1,980 annually on apparel, sporting goods, and consumer electronics as well as hobbies, pets, and gifts. Given that the U.S. Facebook community is approximated at 141.2 million users, we can estimate that U.S. Facebook users account for about $280 billion in retail goods each year. Surprisingly, there are few companies helping consumers share their online purchases, and none are providing a seamless sharing experience for in-store purchases. Additionally, it is unlikely that retailers would want to share their products/consumer purchasing history on a content platform owned by a competitor, so there exists a need in the market for a third party to participate in the social sharing space.

According to 88% of product marketers, the greatest advantage of social media marketing is generating more business exposure. Increased traffic and improved search ranking are also major advantages, according to 72% and 62% of marketers (source: 2011 Social Media Marketing Industry Report, Social Media Examiner, April 2011). Marketers recognize the potential of social media users and are willing to spend significant marketing budgets to target them—some estimate that advertisers have spent upwards of $3.8 billion on Facebook advertisements alone (source: EMarketer Inc.).

In spite of this potential, no retailers or other companies have developed social purchase sharing processes for in-store purchases, even though a majority of customers shop in brick-and-mortar stores. 68% of even the most technologically savvy and “wired” population (adults between 18 and 25) still prefer to shop in a physical store for goods such as apparel and footwear. Current point-of-sale systems are not equipped to integrate with social media platforms or consumer purchase data sharing networks. There exists a need to integrate and/or modify point-of-sale systems so that consumers may share their purchase date.

There are companies, such as Shopsocially, that provide social media solutions for e-commerce purchases. However, these companies require consumers to participate in and maintain a presence on the company's own social shopping network, effectively removing the shopping experience from all other activities the user engages in on their preferred social network. Moreover, companies like Shopsocially ignore more than 90% of the market, as they only provide e-commerce solutions for a small portion of retailers and do not provide for in-store purchases. None of the existing services provide automated sharing processes for in-store purchases, and existing services do not bundle purchases from multiple retailers into one post.

In light of the foregoing, there exists a need for a customer purchase data network system that allows users to track, share, and integrate their shopping with social media networks.

### SUMMARY OF THE INVENTION

Generally, provided is a system and method for sharing user purchase data. Preferably, provided is a system and method for receiving a unique identifier, retrieving a user profile, and retrieving purchase data for an item purchase by a user. Preferably, provided is a system and method for storing the purchase data, displaying at least a portion of the purchase data on a client device, and posting at least a portion of the purchase data on at least one social media platform.

According to one preferred and non-limiting embodiment or aspect, provided is a computer-implemented method for sharing user purchase data, the method including receiving, from a user, a unique identifier associated with a user profile of the user. The method further includes retrieving the user profile from at least one user database based on the unique identifier and retrieving, from at least one product database, purchase data for at least one item purchased by the user through at least one retailer. The method further includes storing the purchase data in the at least one user database and associating the purchase data with the user profile. The method further includes communicating, to a client device of the user, display data configured to generate at least one user interface on the client device comprising a visual representation of at least a portion of the purchase data. The method further includes posting the at least a portion of the purchase data and at least one photograph or video to at least one social media platform.

In non-limiting embodiments or aspects, the method may include receiving, from the client device, a selection of the at least one social media platform and, in response to receiving the selection from the client device, posting the at least a portion of the purchase data. Furthermore, the method may include comparing a predetermined product category corresponding to the at least one item to a plurality of approved product categories associated with the user profile. The method may include, in response to determining that the predetermined product category matches an approved product category of the plurality of approved product categories, automatically posting the at least a portion of the purchase data. Furthermore, the at least one photograph or video may include at least one of the following received from the at least one product database or the client device: a client-provided photograph or video, a retailer-provided photograph or video, a stock photograph or video, or any combination thereof.

In non-limiting embodiments or aspects, the method may also include, in response to the at least one item being purchased by the user, adding or incrementing at least one reward associated with the user profile of the user. The method may also include communicating, to the client device, data configured to generate on the at least one user interface a visual representation of the at least one reward. Further, the method may include communicating, to the client device, data configured to generate on the at least one user interface a visual representation of a plurality of rewards associated with the user profile, and communicating, to the client device, data configured to generate on the at least one user interface a visual representation of a plurality of redemption options for rewards, wherein each redemption option of the plurality of redemption options corresponds to a predetermined number of rewards. The method may include receiving, from the client device, a selected redemption option and removing the predetermined number of rewards corresponding to the selected redemption option from the plurality of rewards.

In non-limiting embodiments or aspects, the method may include, in response to determining that at least one predetermined user action has occurred, associating at least one reward with the user profile. The at least one predetermined user action may include at least one of the following: posting the at least a portion of the purchase data, commenting on a post from another user, rating the at least one item, or any combination thereof.

According to one preferred and non-limiting embodiment or aspect, provided is a system for sharing user purchase data, including at least one user database that includes user purchase data and at least one processor in communication with the at least one user database. The at least one processor is programmed or configured to receive, from a user, a unique identifier associated with a user profile of the user and retrieve the user profile from the at least one user database based on the unique identifier. The at least one processor is also programmed or configured to retrieve, from at least one product database, purchase data for at least one item purchased by the user through at least one retailer, store the purchase data in the at least one user database, and associate the purchase data with the user profile. The at least one processor is further programmed or configured to communicate, to a client device of the user, display data configured to generate at least one user interface on the client device comprising a visual representation of at least a portion of the purchase data. Additionally, the at least one processor is programmed or configured to post the at least a portion of the purchase data and at least one photograph or video to at least one social media platform.

In non-limiting embodiments or aspects, the at least one processor may be programmed or configured to receive, from the client device, a selection of the at least one social media platform and, in response to receiving the selection from the client device, post the at least a portion of the purchase data. The at least one processor may be further programmed or configured to compare a predetermined product category corresponding to the at least one item to a plurality of approved product categories associated with the user profile and, in response to determining that the predetermined product category matches an approved product category of the plurality of approved product categories, post the at least a portion of the purchase data. The at least one photograph or video may include at least one of the following received from the at least one product database or the client device: a client-provided photograph or video, a retailer-provided photograph or video, a stock photograph or video, or any combination thereof.

In non-limiting embodiments or aspects, the at least one processor may be programmed or configured to, in response to the at least one item being purchased by the user, add or increment at least one reward associated with the user profile of the user. The at least one processor may be programmed or configured to communicate, to the client device, data configured to generate on the at least one user interface a visual representation of the at least one reward. The at least one processor also may be further programmed or configured to communicate, to the client device, data configured to generate on the at least one user interface a visual representation of a plurality of rewards associated with the user profile, and communicate, to the client device, data configured to generate on the at least one user interface a visual representation of a plurality of redemption options for rewards, wherein each redemption option of the plurality of redemption options corresponds to a predetermined number of rewards. The at least one processor may be further programmed or configured to receive, from the client device, a selected redemption option and remove the predetermined number of rewards corresponding to the selected redemption option from the plurality of rewards.

In non-limiting embodiments or aspects, the at least one processor may be programmed or configured to, in response to determining that at least one predetermined user action has occurred, associate at least one reward with the user profile. The at least one predetermined user action may include at least one of the following: posting the at least a portion of the purchase data, commenting on a post from another user, rating the at least one item, or any combination thereof.

According to one preferred and non-limiting embodiment or aspect, provided is an apparatus for sharing user purchase data comprising at least one non-transitory computer-readable medium having program instructions stored thereon that, when executed by at least one processor, cause the at least one processor to receive, from a user, a unique identifier associated with a user profile of the user and retrieve the user profile from at least one user database based on the unique identifier. The program instructions further cause the at least one processor to retrieve, from at least one product database, purchase data for at least one item purchased by the user through at least one retailer, store the purchase data in the at least one user database, and associate the purchase data with the user profile. The program instructions further cause the at least one processor to communicate, to a client device of the user, display data configured to generate at least one user interface on the client device comprising a visual representation of at least a portion of the purchase data, and post the at least a portion of the purchase data and at least one photograph or video to at least one social media platform.

In non-limiting embodiments or aspects, the program instructions, when executed by the at least one processor, may further cause the at least one processor to receive, from the client device, a selection of the at least one social media platform and, in response to receiving the selection from the client device, post the at least a portion of the purchase data. The program instructions may further cause the at least one processor to compare a predetermined product category corresponding to the at least one item to a plurality of approved product categories associated with the user profile, and, in response to determining that the predetermined product category matches an approved product category of the plurality of approved product categories, automatically post the at least a portion of the purchase data. Furthermore, the at least one photograph or video may include at least one of the following received from the at least one product database or the client device: a client-provided photograph or video, a retailer-provided photograph or video, a stock photograph or video, or any combination thereof.

Further preferred and non-limiting embodiments or aspects will now be described in the following numbered clauses.

Clause 1: a computer-implemented method for sharing user purchase data, comprising: receiving, from a user, a unique identifier associated with a user profile of the user; retrieving the user profile from at least one user database based on the unique identifier; retrieving, from at least one product database, purchase data for at least one item purchased by the user through at least one retailer; storing the purchase data in the at least one user database and associating the purchase data with the user profile; communicating, to a client device of the user, display data configured to generate at least one user interface on the client device comprising a visual representation of at least a portion of the purchase data; and posting the at least a portion of the purchase data and at least one photograph or video to at least one social media platform.

Clause 2: the computer-implemented method of clause 1, further comprising: receiving, from the client device, a selection of the at least one social media platform; and in response to receiving the selection from the client device, posting the at least a portion of the purchase data.

Clause 3: the computer-implemented method of clauses 1 or 2, further comprising: comparing a predetermined product category corresponding to the at least one item to a plurality of approved product categories associated with the user profile; and in response to determining that the predetermined product category matches an approved product category of the plurality of approved product categories, automatically posting the at least a portion of the purchase data.

Clause 4: the computer-implemented method of any of clauses 1-3, wherein the at least one photograph or video comprises at least one of the following received from the at least one product database or the client device: a client-provided photograph or video, a retailer-provided photograph or video, a stock photograph or video, or any combination thereof.

Clause 5: the computer-implemented method of any of clauses 1-4, further comprising: in response to the at least one item being purchased by the user, adding or incrementing at least one reward associated with the user profile of the user; and communicating, to the client device, data configured to generate on the at least one user interface a visual representation of the at least one reward.

Clause 6: the computer-implemented method of any of clauses 1-5, further comprising: communicating, to the client device, data configured to generate on the at least one user interface a visual representation of a plurality of rewards associated with the user profile; communicating, to the client device, data configured to generate on the at least one user interface a visual representation of a plurality of redemption options for rewards, wherein each redemption option of the plurality of redemption options corresponds to a predetermined number of rewards; receiving, from the client device, a selected redemption option; and removing the predetermined number of rewards corresponding to the selected redemption option from the plurality of rewards.

Clause 7: the computer-implemented method of any of clauses 1-6, further comprising, in response to determining that at least one predetermined user action has occurred, associating at least one reward with the user profile.

Clause 8: the computer-implemented method of any of clauses 1-7, wherein the at least one predetermined user action comprises at least one of the following: posting the at least a portion of the purchase data, commenting on a post from another user, rating the at least one item, or any combination thereof.

Clause 9: a system for sharing user purchase data, comprising: at least one user database comprising user purchase data; at least one processor in communication with the at least one user database, the at least one processor programmed or configured to: receive, from a user, a unique identifier associated with a user profile of the user; retrieve the user profile from the at least one user database based on the unique identifier; retrieve, from at least one product database, purchase data for at least one item purchased by the user through at least one retailer; store the purchase data in the at least one user database and associate the purchase data with the user profile; communicate, to a client device of the user, display data configured to generate at least one user interface on the client device comprising a visual representation of at least a portion of the purchase data; and post the at least a portion of the purchase data and at least one photograph or video to at least one social media platform.

Clause 10: the system of clause 9, wherein the at least one processor is further programmed or configured to: receive, from the client device, a selection of the at least one social media platform; and in response to receiving the selection from the client device, post the at least a portion of the purchase data.

Clause 11: the system of clauses 9 or 10, wherein the at least one processor is further programmed or configured to: compare a predetermined product category corresponding to the at least one item to a plurality of approved product categories associated with the user profile; and in response to determining that the predetermined product category matches an approved product category of the plurality of approved product categories, post the at least a portion of the purchase data.

Clause 12: the system of any of clauses 9-11, wherein the at least one photograph or video comprises at least one of the following received from the at least one product database or the client device: a client-provided photograph or video, a retailer-provided photograph or video, a stock photograph or video, or any combination thereof.

Clause 13: the system of any of clauses 9-12, wherein the at least one processor is further programmed or configured to: in response to the at least one item being purchased by the user, add or increment at least one reward associated with the user profile of the user; and communicate, to the client device, data configured to generate on the at least one user interface a visual representation of the at least one reward.

Clause 14: the system of any of clauses 9-13, wherein the at least one processor is further programmed or configured to: communicate, to the client device, data configured to generate on the at least one user interface a visual representation of a plurality of rewards associated with the user profile; communicate, to the client device, data configured to generate on the at least one user interface a visual representation of a plurality of redemption options for rewards, wherein each redemption option of the plurality of redemption options corresponds to a predetermined number of rewards; receive, from the client device, a selected redemption option; and remove the predetermined number of rewards corresponding to the selected redemption option from the plurality of rewards.

Clause 15: the system of any of clauses 9-14, wherein the at least one processor is further programmed or configured to, in response to determining that at least one predetermined user action has occurred, associate at least one reward with the user profile.

Clause 16: the system of any of clauses 9-15, wherein the at least one predetermined user action comprises at least one of the following: posting the at least a portion of the purchase data, commenting on a post from another user, rating the at least one item, or any combination thereof.

Clause 17: an apparatus for sharing user purchase data comprising at least one non-transitory computer-readable medium having program instructions stored thereon that, when executed by at least one processor, cause the at least one processor to: receive, from a user, a unique identifier associated with a user profile of the user; retrieve the user profile from at least one user database based on the unique identifier; retrieve, from at least one product database, purchase data for at least one item purchased by the user through at least one retailer; store the purchase data in the at least one user database and associate the purchase data with the user profile; communicate, to a client device of the user, display data configured to generate at least one user interface on the client device comprising a visual representation of at least a portion of the purchase data; and post the at least a portion of the purchase data and at least one photograph or video to at least one social media platform.

Clause 18: the apparatus of clause 17, wherein the program instructions, when executed by the at least one processor, further cause the at least one processor to: receive, from the client device, a selection of the at least one social media platform; and in response to receiving the selection from the client device, post the at least a portion of the purchase data.

Clause 19: the apparatus of clauses 17 or 18, wherein the program instructions, when executed by the at least one processor, further cause the at least one processor to: compare a predetermined product category corresponding to the at least one item to a plurality of approved product categories associated with the user profile; and in response to determining that the predetermined product category matches an approved product category of the plurality of approved product categories, automatically post the at least a portion of the purchase data.

Clause 20: the apparatus of any of clauses 17-19, wherein the at least one photograph or video comprises at least one of the following received from the at least one product database or the client device: a client-provided photograph or video, a retailer-provided photograph or video, a stock photograph or video, or any combination thereof.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic diagram of a non-limiting embodiment or aspect of a system for sharing user purchase data according to the principles of the present invention;

FIG. 2 is a flow diagram of a non-limiting embodiment or aspect of a method for sharing user purchase data by prompting user input according to the principles of the present invention;

FIG. 3 is a flow diagram of a non-limiting embodiment or aspect of a method for sharing user purchase data by an automated process according to the principles of the present invention;

FIG. 4 is a schematic view of a non-limiting embodiment or aspect of a system for sharing user purchase data according to the principles of the present invention;

FIG. 5A is a schematic view of a non-limiting embodiment or aspect of a system for sharing user purchase data according to the principles of the present invention; and

FIG. 5B is a schematic view of a non-limiting embodiment or aspect of a system for sharing user purchase data according to the principles of the present invention.

### DETAILED DESCRIPTION OF THE INVENTION

For purposes of the description hereinafter, it is to be understood that the specific systems, processes, functions, and modules illustrated in the drawings, and described in the following specification, are simply exemplary embodiments of the invention. Hence, specific characteristics related to the embodiments disclosed herein are not to be considered as limiting. Further, it is to be understood that the invention may assume various alternative variations and step sequences, except where expressly specified to the contrary.

In the following description, numerous specific details are provided, such as network structures, database structures, computing devices, and programming to provide a thorough understanding of embodiments of the invention. One skilled in the art will recognize, however, that the invention can be practiced without one or more of the specific details, or with other methods, components, materials, and so forth. In other instances, well-known structures, materials, or operations are not shown or described in detail to avoid obscuring aspects of the invention.

As used herein, the terms “communication” and “communicate” refer to the receipt, transmission, or transfer of one or more signals, messages, commands, or other type of data. For one unit or device to be in communication with another unit or device means that the one unit or device is able to receive data from and/or transmit data to the other unit or device. A communication may use a direct or indirect connection, and may be wired and/or wireless in nature. Additionally, two units or devices may be in communication with each other even though the data transmitted may be modified, processed, routed, etc., between the first and second unit or device. For example, a first unit may be in communication with a second unit even though the first unit passively receives data, and does not actively transmit data to the second unit. As another example, a first unit may be in communication with a second unit if an intermediary unit processes data from one unit and transmits processed data to the second unit. It will be appreciated that numerous other arrangements are possible. Any known electronic communication protocols and/or algorithms may be used such as, for example, TCP/IP (including HTTP and other protocols), WLAN (including 802.11 and other radio frequency-based protocols and methods), analog transmissions, Global System for Mobile Communications (GSM), and/or the like.

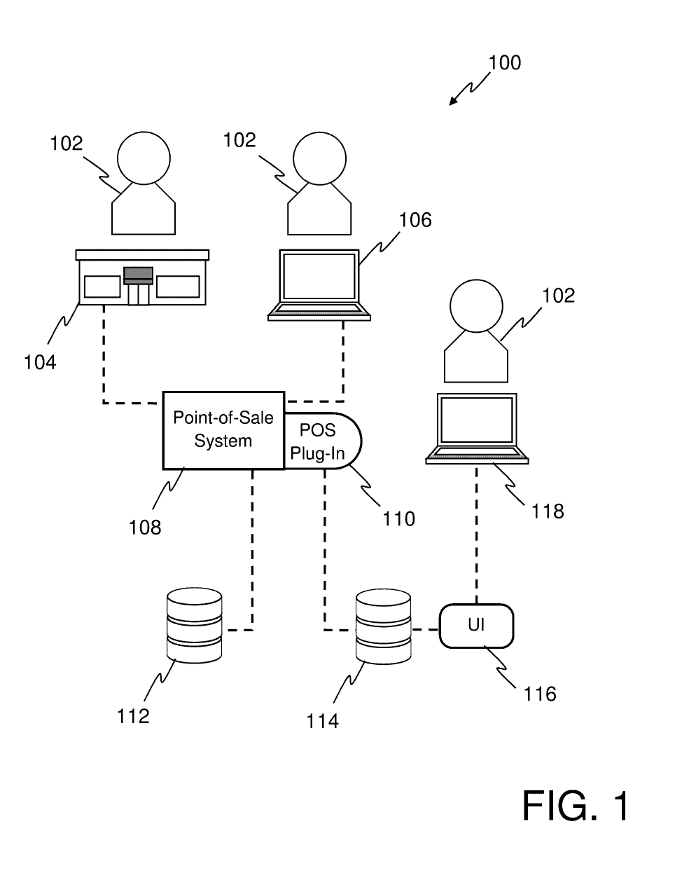

Referring to FIG. 1, a system 100 for tracking, sharing, and integrating shopping with social media networks is shown according to a preferred and non-limiting embodiment or aspect. A user 102 may purchase items at a storefront 104, e.g., a brick-and-mortar retail store, or on an online store 106, e.g., an e-commerce website, which are communicatively connected to a point-of-sale system 108. The point-of-sale system 108 may be one or more servers, computers, processors, and/or databases that facilitate sales transactions at the storefront 104 or on the online store 106. There may be more than one point-of-sale system 108, such as one system in communication with the storefront 104 and another system in communication with the online store 106. There may also be a plurality of point-of-sale systems 108 for a plurality of retailers that may have storefronts 104, online stores 106, or combinations thereof. For a given point-of-sale system 108, a point-of-sale plug-in 110, e.g., an application programming interface (API), which performs user purchase data network operations, is in communication with the point-of-sale system 108. When a user 102 purchases an item from a storefront 104 or an online store 106, the point-of-sale system 108 stores purchase data representative of the purchased item in a retailer database 112. The point-of-sale system 108 is given a unique identifier, e.g., a user ID, a phone number, a username, and/or the like, by the user 102 and communicates with the point-of-sale plug-in 110 to verify the user's 102 user profile. If the given unique identifier matches that of an existing user, the user profile is verified. Additional identifying information or credentials may be required from the user 102 for added security. The plug-in 110 then communicates with the retailer database 112, either directly or indirectly, such as through the point-of-sale system 108, and accesses at least a portion of the purchase data. The plug-in 110 is also in communication with a user database 114 and stores the purchase data in the user database 114 in relation to the user profile. For example, a user's 102 purchase history may be saved in the user database 114 as multiple entries of purchase data that are associated with their respective user profile. The user database 114 communicates purchase data to a user 102 through a user interface 116 accessible by a client device 118, e.g., a smartphone, tablet, desktop computer, laptop computer, etc. A user 102 interacts with the user interface 116 on the client device 118 to view, edit, and/or save purchase data and user data on the user database 114.

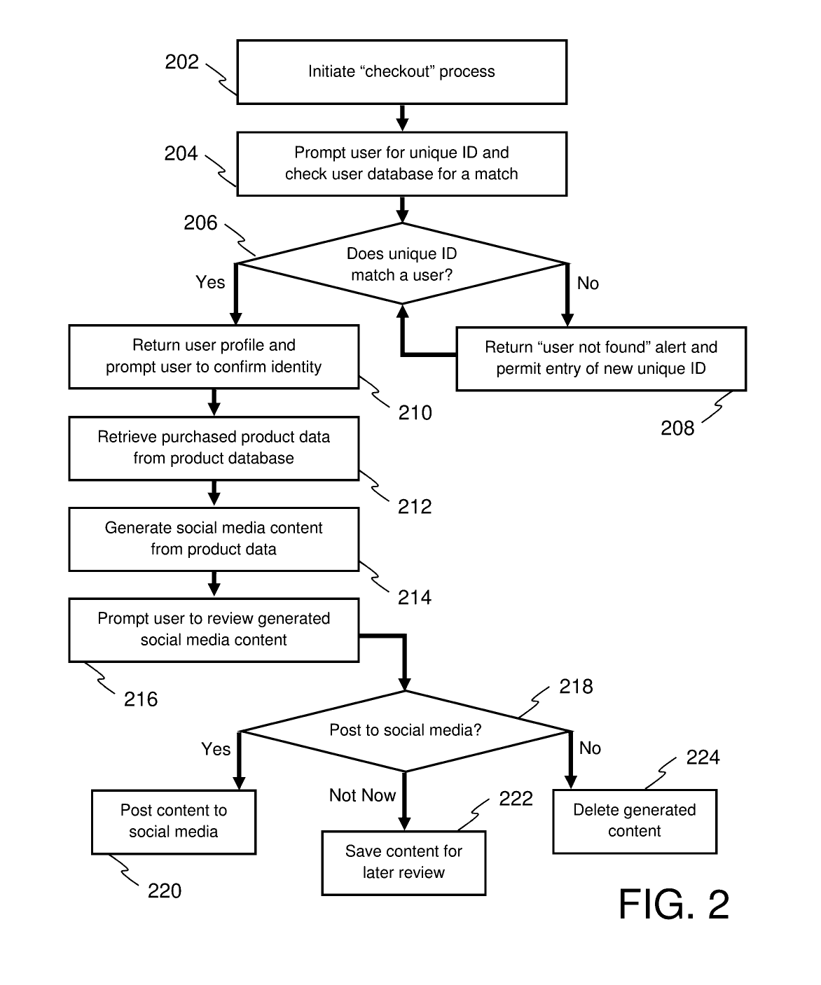

Referring to FIG. 2, a method for tracking, sharing, and integrating shopping with social media networks is shown according to a preferred and non-limiting embodiment or aspect. The depicted method posts social media content related to a user purchase after receiving confirmation and instructions from a user. Depicted is a computer-implemented method operated by a processor (e.g., a server computer) that begins at step 202 when a user (e.g., a consumer) is purchasing or has completed purchasing an item, either through an e-commerce vendor or at a physical store. This initiates the checkout process at step 202. At step 204, the processor prompts the user for a unique identifier, such as a phone number, which the processor compares against a user database to determine if the given unique identifier matches a unique identifier of an existing user, at step 206. If the given unique identifier does not match the unique identifier of an existing user, the processor communicates to the user that it failed to find a match, at step 208. The processor may also permit or prompt the user to enter a new unique identifier at step 208, after which it will return to step 206 and compare the newly entered unique identifier to unique identifiers in the user database. It is noted that, due to the separation of the application of the present invention from a vendor's sales process, no credit card or personal financial information need be collected by the system of the present invention. By not collecting, exchanging, or storing credit card data and the like, security for both the application provider and vendors is greatly increased.

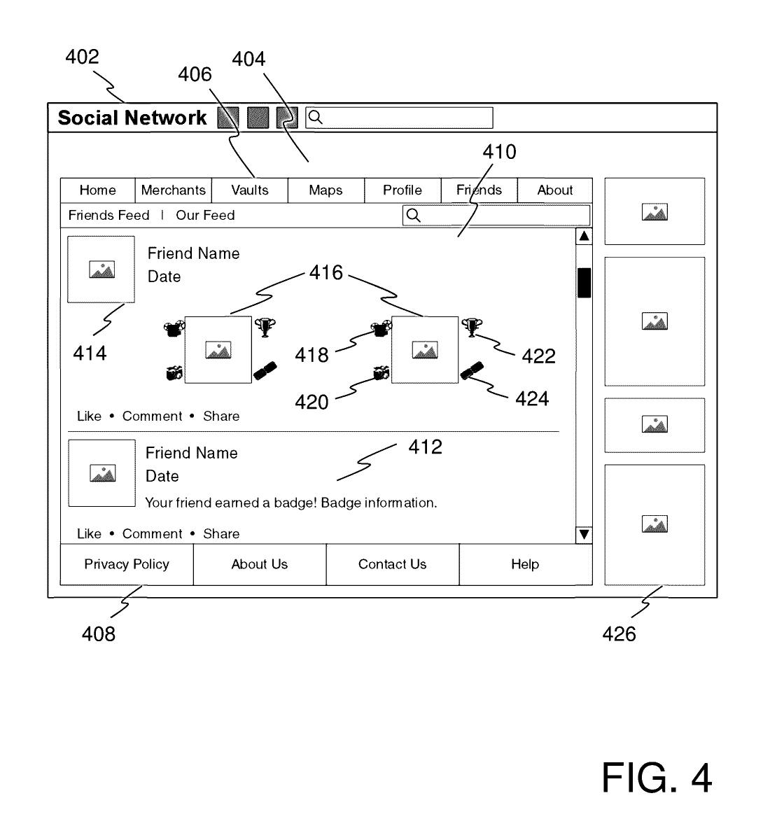

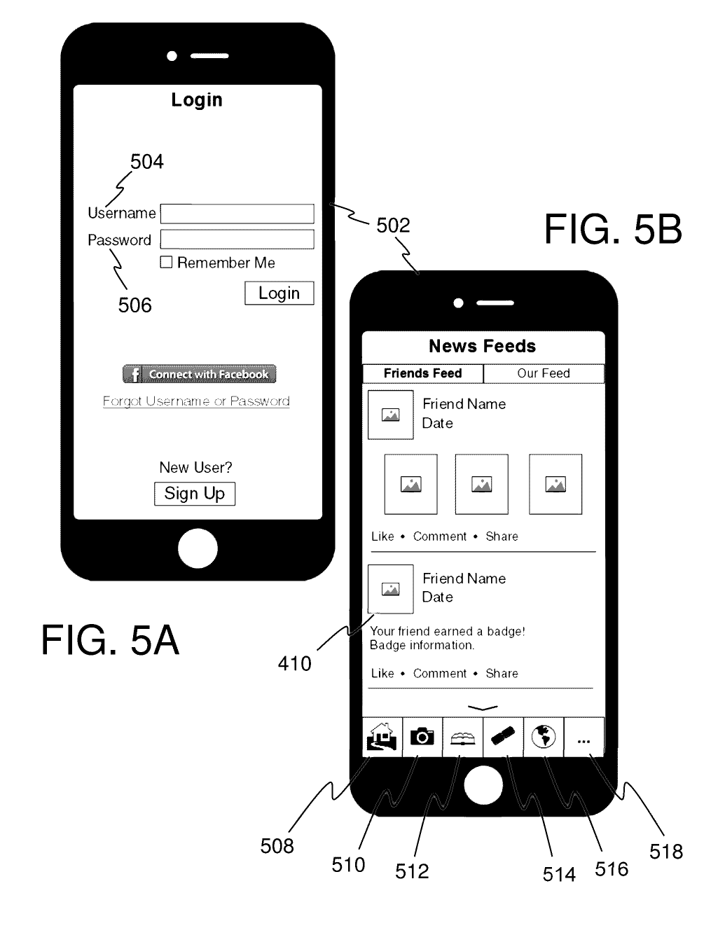

With further reference to FIG. 2, and in further non-limiting embodiments or aspects, if the processor finds a unique identifier of an existing user that matches the unique identifier entered by the user in step 206, the processor proceeds to return identifying data related to the matched user profile, at step 210. The identifying data may include a name, a username, a user profile image, and/or the like. At step 210, the processor may prompt the user to confirm their identity by verifying the identified user profile. Step 210 may additionally include a security measure, such as the entering of a further unique identifier or password. If the user verifies that the identified user profile is correct, the processor communicates with a product database and retrieves product data corresponding to the user's purchased item, at step 212. It will be appreciated that the user need not verify that the profile is correct in order for the processor to proceed to retrieve product data, and verification may be conducted by another means, such as programmatically. Product data may include, but is not limited to: product name, product price, product brand, product image, product discount savings, product location, and/or any combination thereof. It will be appreciated that relevant product data may also be retrieved by the processor prior to step 202, via an e-commerce checkout process or by fetching the product data prior to the user completing their purchase transaction. After the processor has identified the correct user profile and gathered product data corresponding to the purchased item, the processor then generates social media content from the product data, at step 214. The generated social media content may be specific to one or more social media platforms (e.g., Facebook, Twitter, Google+, Instagram, Pinterest, and/or the like) that are associated with the user profile. Example non-limiting embodiments of generated social media content, after being posted to a social media platform, are depicted in FIG. 4 and FIG. 5B.

With further reference to FIG. 2, and in further non-limiting embodiments or aspects, after the processor generates social media content at step 214, the processor prompts the user to review the generated social media content at step 216 and requests user permission to post the content to one or more social media platforms at step 218. The user profile may already be linked to one or more social media platforms, or the user may have to select or log in to chosen social media platforms. If the user approves the generated content, the processor posts the content to one or more social media platforms at step 220. If the user does not want to post the content at that moment, but also does not want to discard the generated content, they may choose to save the content for later review at step 222. Step 222 may also allow the user to edit the generated content prior to posting the content to a social media platform. If the user does not want to post the generated content and does not want to save the content for later review, they may choose to delete the content at step 224. It will further be appreciated that the foregoing steps may be operated by one or more processors.

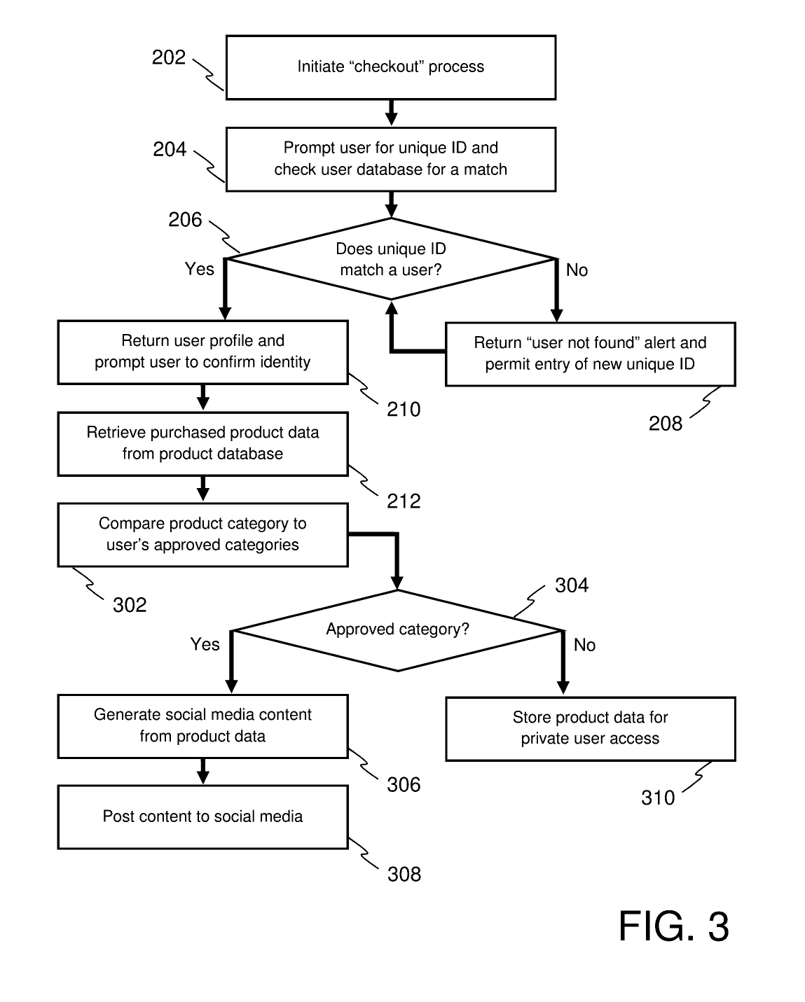

Referring to FIG. 3, a method for tracking, sharing, and integrating shopping with social media networks is shown according to a preferred and non-limiting embodiment or aspect. The depicted method automatically posts social media content related to a user purchase after checking the user's pre-approved product categories. Depicted is a computer-implemented method operated by a processor (e.g., a server computer) that begins at step 202 when a user (e.g., a consumer) is purchasing or has completed purchasing an item, either through an e-commerce vendor or at a physical store. This initiates the checkout process at step 202. At step 204, the processor prompts the user for a unique identifier, such as a phone number, which the processor compares against a user database to determine if the given unique identifier matches a unique identifier of an existing user, at step 206. If the given unique identifier does not match the unique identifier of an existing user, the processor communicates to the user that it failed to find a match, at step 208. The processor may also permit or prompt the user to enter a new unique identifier at step 208, after which it will return to step 206 and compare the newly-entered unique identifier to unique identifiers in the user database.

With further reference to FIG. 3, and in further non-limiting embodiments or aspects, if the processor finds a unique identifier of an existing user that matches the unique identifier entered by the user in step 206, the processor proceeds to return identifying data related to the matched user profile at step 210. The identifying data may include a name, a username, a user profile image, and/or the like. At step 210, the processor may prompt the user to confirm their identity by verifying the identified user profile. Step 210 may additionally include a security measure, such as the entering of a further unique identifier or password. If the user verifies that the identified user profile is correct, the processor communicates with a product database and retrieves product data corresponding to the user's purchased item, at step 212. It will be appreciated that the user need not verify that the profile is correct in order for the processor to proceed to retrieve product data, and verification may be conducted by another means, such as programmatically. Product data may include, but is not limited to: product name, product price, product brand, product image, product discount savings, product location, and/or any combination thereof. It will be appreciated that relevant product data may also be retrieved by the processor prior to step 202, via an e-commerce checkout process or by fetching the product data prior to the user completing their purchase transaction. After the processor has identified the correct user profile and gathered product data corresponding to the purchased item, the processor compares the purchased item's product category to the approved product categories corresponding to the user profile at step 302.

With further reference to FIG. 3, if the processor determines that the purchased item's product category matches an approved category associated with the user profile at step 304, the processor generates social media content from the product data at step 306. The generated social media content may be specific to one or more social media platforms (e.g., Facebook, Twitter, Google+, Instagram, Pinterest, and/or the like) that are associated with the user profile. Example non-limiting embodiments of generated social media content, after being posted to a social media platform, are depicted in FIG. 4 and FIG. 5B. Once the social media content is generated, the processor posts the content to one or more social media platforms at step 308. If, however, the purchased item's product category does not match an approved category associated with the user profile at step 304, the processor stores the product data for later private access and review by the user at step 310. At that later review, the user may choose to post the product data to a social media network or delete the purchase data. It will further be appreciated that the foregoing steps may be operated by one or more processors.

Referring to FIG. 4, a system for tracking, sharing, and integrating shopping with social media networks is shown according to a preferred and non-limiting embodiment or aspect. Depicted is a schematic view of a social media interface 402 as displayed on a client device of a user, e.g., a desktop computer, a laptop computer, a tablet computer, and/or the like. As shown, the social media interface 402 is logged in to the user's social media profile, and the system application 404 of the present invention is displayed within the social media interface 402. It will be appreciated that the system application 404 may also operate independently of the social media interface 402, such as in a standalone website or social media network. When a user logs in to the application 404 for the first time, they will be presented with a user profile page so that they can set up their user profile and select product category preferences, specifically those product categories which the user approves for auto-posting to social media. When a user logs in to the application over subsequent visits, they will be presented with an application 404 home page, such as depicted in FIG. 4. The application 404 may comprise a primary navigation bar 406, which may include alternate views such as a home view, a merchants view, a vaults view, a maps view, a profile view, a friends view, an about view, or any combination thereof. As part of a secondary navigation bar 408, or integrated into the primary navigation bar, other views may include a privacy policy view, an about us view, a contact us view, and a help view.

With further reference to FIG. 4, and in further non-limiting embodiments or aspects, the home view may be associated with social media content feeds. A content feed may comprise social media informational content related to event triggers, such as: when a user purchases products from any store; when a user acquires a coupon; when a user acquires an achievement, trophy, title, or badge; when a user geographically “checks in,” i.e., broadcasts their physical presence in, a store; when a user receives a gift; when a user gift is revealed; and/or the like. Social media content generated from these events may be associated with the user profile of the user accessing the system application 404, or may be associated with other user accounts related to the user profile, such as “friends.” Social media content may be interacted with by users, such as by “liking” the content, sharing the content, commenting on the content, and/or like social media actions. The schematic view of FIG. 4 depicts two such content feed items: a shopping event post 410 and a badge achievement post 412. The shopping event post 410 may comprise a friend's name, the date of the event, and the friend's user profile picture 414. The shopping event post also may comprise one or more purchased items 416, and one or more item details corresponding to a purchased item, which may be accessed by respective controls. The item details may including user video of the purchased item 418, user pictures of the purchased item 420, trophies earned by purchasing the item 422, and coupons used to purchase the item 424. Photographs and video of the purchase item may be provided by the user, by the retailer, or may be stock imagery. The item-related controls need not be displayed if they are not applicable to the purchased item, such as if the user did not post video or pictures of the purchased item, did not earn any trophies, and/or did not use any coupons. Furthermore, the application may include one or more third-party advertisements 426, which may be advertisement videos or images, provided as a means of monetizing the application and reducing costs, if any, to the end user.

With further reference to FIG. 4, and in further non-limiting embodiments or aspects, displayed purchased items 416 may be selected or clicked to display a detail view of the purchased item 416. The detail view may allow the user to add the item to a shopping cart, comment on the item, “like” the item, share the item on social media, add the item to a user wishlist, suggest the item to their friends, and/or take like actions. Other product detail information may be provided to the user, which may include, but is not limited to: purchase date, name, vendor, cost, description, dimensions, specifications, or any combination thereof. For products that are a part of the user's purchase history and content feed, the system provides the user the ability to “share” or “not share” individual items. Shared items may be indicated by full color product images, and not shared (i.e., private) items may be indicated by black and white product images. Furthermore, social media content feeds for users and a user's friends may be shown in combination or independently. It will be appreciated that other configurations are possible.

With further reference to FIG. 4, and in further non-limiting embodiments or aspects, the merchants view is configured to provide the user with a list of all merchants and/or individual brand lists and retailer lists. Users may select a merchant, brand, or retailer name/logo from the list and be directed to a corresponding vendor website. The list of merchants may be compiled automatically by referencing merchant accounts registered to participate in the service of the present invention. In a preferred embodiment, merchants sign up to participate in the application of the present invention and are given independent merchant accounts to control listings of their products, promotions, discounts, and other retailer information. Merchant interfaces are described in further detail below, and it will be appreciated that other configurations are possible.

With further reference to FIG. 4, and in further non-limiting embodiments or aspects, the vaults view is configured to provide the user with a list of rewards that the user has unlocked by performing various activities on the application. For example, merchants (i.e., vendors) may provide rewards to users for completing certain actions, such as, but not limited to: scanning a number of item barcodes, checking into the store a number of times, purchasing a number of items, sharing a number of product links, and/or the like. The rewards may take the form of reward points, electronic badges and achievements, coupons and discounts, or merchandise. Rewards or reward points that require redemption to receive their benefit may be redeemed directly from the vaults view. It will be appreciated that other reward systems are possible and within the spirit of the present invention.

With further reference to FIG. 4, and in further non-limiting embodiments or aspects, the maps view is configured to allow the user to select a location, select a distance, and view locations of nearby merchants. The profile view is configured to allow the user to view and edit user profile information, such as personal information, purchase history, received gifts, scanned products, category preferences, friend lists, friend wishlists, and/or the like. It will be appreciated that the application may present the stored data in various alternative ways and is not limited to the number or configuration of views as depicted.

Referring to FIGS. 5A and 5B, a system for tracking, sharing, and integrating shopping with social media networks is shown according to preferred and non-limiting embodiments or aspects. Depicted are schematic views of a social media interface as displayed on a mobile client device 502 of a user, e.g., a smartphone and/or the like. The interface may be an online accessible application or available as a downloadable application. The application may prompt a user for user profile credentials, such as a username 504 and password 506, prior to logging into the application, as shown in FIG. 5A. A user may also access the application by inputting user credentials from a social media network, such as Facebook. Once the user is logged into the application, as depicted in FIG. 5B, the user may view an arrangement of content similar to the application as depicted in FIG. 4. All of the features as described in FIG. 4 may be reformatted for access on the mobile application shown in FIGS. 5A and 5B.

With further reference to FIG. 5B, and in further non-limiting embodiments or aspects, the application may display a navigation bar comprising a number of views and controls, which may include: a home view 508, a barcode scanner tool 510, a merchant directory 512, a discounts and rewards view 514, a maps view 516, and an additional tools and views icon 518. The home view 508 may include a social media content feed similar to that of FIG. 4. The barcode scanner tool 510 may employ a camera of the client device to scan an item's barcode, subsequently look up the scanned product, and display a list of vendors that sell the scanned item. Upon selection of a vendor, product details may be displayed to the user, such as: name, price, website, ratings, reviews, vendor location, description, and/or like information. The barcode scanner tool may also be configured to allow the user to add the item to an e-commerce shopping cart, share the product on social media, or save the item to a wishlist. The merchant directory 512 may include a list of all merchants who participate in the system of the present invention, as described above. A user may view a list of brands or a list of retailers and navigate to brand/retailer websites by clicking on a listing. The discounts and rewards view 514 may provide a list of discount cards and rewards cards provided by merchants to users. Discounts and rewards may be presented to users based on user actions, such as proximity to stores, purchases, barcode scans, posting to social media, commenting on a post from another user, rating a purchase item, and/or any like user action. As with the rewards view discussed in connection with FIG. 4, users may be presented with a list of selectable redemption options that may be redeemed in exchange for earned rewards, such as reward points or coupons. Redemption options may be electronic, such as badges, application features, achievements, and/or the like; or physical, such as merchandise. The map view 516 may provide the user with a navigable map showing merchant locations within a predefined or variable distance from the user, or from a location entered by the user.

In further non-limiting embodiments or aspects, when a user first creates a user profile with the system of the present invention, they may be prompted to select one or more product categories they wish to have shared to social media automatically. A predetermined list of product categories may be provided to the user. For example, a user may choose to automatically post purchases related to shoes, but not to post purchases related to socks. At any later time, a user may return to the profile settings of their user profile and edit their chosen approved product categories. Moreover, a user's purchase history may be organized according to shopping trips and may display purchased items in folders by trips over time. For example, if a user purchases ten items at three different stores over the course of an hour, the application may group those purchases and display them together as a combined shopping trip. As the user makes separate shopping trips over different outings, the trips may be ordered in sequence to present a list of the user's purchase history. One method for organizing a user's purchase history is by grouping items purchased by day and displaying days in chronological order. It will be appreciated that other methods or algorithms are possible.

In further non-limiting embodiments or aspects, a system administrator may be provided with an admin interface (i.e., dashboard) to manage user and merchant accounts. The admin dashboard may be an online portal accessible by a web-enabled device and may be configured to allow an administrator to create merchant accounts, view merchant profile information, view merchant-uploaded products, remove merchants, contact merchants, manage users, track users, view user activities, deactivate users, send system messages, manage application content, and/or the like. Furthermore, merchants (i.e., vendors) may be provided with a merchant interface (i.e., dashboard) to manage their commercial interactions. The merchant dashboard may be an online portal accessible by a web-enabled device and may be configured to allow a merchant to add new products, view product sales, view product social media, send rewards to users, remove products, create user incentive or reward programs, and/or the like. Additional screens and views that depict further non-limiting embodiments or aspects of the present invention are provided in the U.S. Provisional Patent Application No. 62/199,077 and are incorporated herein by reference.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A computer-implemented method for sharing user purchase data, comprising:
receiving, from a user, a unique identifier associated with a user profile of the user;
retrieving the user profile from at least one user database based on the unique identifier;
retrieving, from at least one product database, purchase data for at least one item purchased by the user through at least one retailer;
storing the purchase data in the at least one user database and associating the purchase data with the user profile;
communicating, to a client device of the user, display data configured to generate at least one user interface on the client device comprising a visual representation of at least a portion of the purchase data; and
posting the at least a portion of the purchase data and at least one photograph or video to at least one social media platform.

2. The computer-implemented method of claim 1, further comprising:
receiving, from the client device, a selection of the at least one social media platform; and
in response to receiving the selection from the client device, posting the at least a portion of the purchase data.

3. The computer-implemented method of claim 1, further comprising:
comparing a predetermined product category corresponding to the at least one item to a plurality of approved product categories associated with the user profile; and
in response to determining that the predetermined product category matches an approved product category of the plurality of approved product categories, automatically posting the at least a portion of the purchase data.

4. The computer-implemented method of claim 1, wherein the at least one photograph or video comprises at least one of the following received from the at least one product database or the client device: a client-provided photograph or video, a retailer-provided photograph or video, a stock photograph or video, or any combination thereof.

5. The computer-implemented method of claim 1, further comprising:
in response to the at least one item being purchased by the user, adding or incrementing at least one reward associated with the user profile of the user; and
communicating, to the client device, data configured to generate on the at least one user interface a visual representation of the at least one reward.

6. The computer-implemented method of claim 5, further comprising:
communicating, to the client device, data configured to generate on the at least one user interface a visual representation of a plurality of rewards associated with the user profile;
communicating, to the client device, data configured to generate on the at least one user interface a visual representation of a plurality of redemption options for rewards, wherein each redemption option of the plurality of redemption options corresponds to a predetermined number of rewards;
receiving, from the client device, a selected redemption option; and
removing the predetermined number of rewards corresponding to the selected redemption option from the plurality of rewards.

7. The computer-implemented method of claim 1, further comprising, in response to determining that at least one predetermined user action has occurred, associating at least one reward with the user profile.

8. The computer-implemented method of claim 7, wherein the at least one predetermined user action comprises at least one of the following: posting the at least a portion of the purchase data, commenting on a post from another user, rating the at least one item, or any combination thereof.

9. A system for sharing user purchase data, comprising:
at least one user database comprising user purchase data;
at least one processor in communication with the at least one user database, the at least one processor programmed or configured to:
receive, from a user, a unique identifier associated with a user profile of the user;
retrieve the user profile from the at least one user database based on the unique identifier;
retrieve, from at least one product database, purchase data for at least one item purchased by the user through at least one retailer;
store the purchase data in the at least one user database and associate the purchase data with the user profile;
communicate, to a client device of the user, display data configured to generate at least one user interface on the client device comprising a visual representation of at least a portion of the purchase data; and
post the at least a portion of the purchase data and at least one photograph or video to at least one social media platform.

10. The system of claim 9, wherein the at least one processor is further programmed or configured to:
receive, from the client device, a selection of the at least one social media platform; and
in response to receiving the selection from the client device, post the at least a portion of the purchase data.

11. The system of claim 9, wherein the at least one processor is further programmed or configured to:
compare a predetermined product category corresponding to the at least one item to a plurality of approved product categories associated with the user profile; and
in response to determining that the predetermined product category matches an approved product category of the plurality of approved product categories, post the at least a portion of the purchase data.

12. The system of claim 9, wherein the at least one photograph or video comprises at least one of the following received from the at least one product database or the client device: a client-provided photograph or video, a retailer-provided photograph or video, a stock photograph or video, or any combination thereof.

13. The system of claim 9, wherein the at least one processor is further programmed or configured to:
in response to the at least one item being purchased by the user, add or increment at least one reward associated with the user profile of the user; and
communicate, to the client device, data configured to generate on the at least one user interface a visual representation of the at least one reward.

14. The system of claim 13, wherein the at least one processor is further programmed or configured to:
communicate, to the client device, data configured to generate on the at least one user interface a visual representation of a plurality of rewards associated with the user profile;
communicate, to the client device, data configured to generate on the at least one user interface a visual representation of a plurality of redemption options for rewards, wherein each redemption option of the plurality of redemption options corresponds to a predetermined number of rewards;
receive, from the client device, a selected redemption option; and
remove the predetermined number of rewards corresponding to the selected redemption option from the plurality of rewards.

15. The system of claim 9, wherein the at least one processor is further programmed or configured to, in response to determining that at least one predetermined user action has occurred, associate at least one reward with the user profile.

16. The system of claim 15, wherein the at least one predetermined user action comprises at least one of the following: posting the at least a portion of the purchase data, commenting on a post from another user, rating the at least one item, or any combination thereof.

17. An apparatus for sharing user purchase data comprising at least one non-transitory computer-readable medium having program instructions stored thereon that, when executed by at least one processor, cause the at least one processor to:
receive, from a user, a unique identifier associated with a user profile of the user;
retrieve the user profile from at least one user database based on the unique identifier;
retrieve, from at least one product database, purchase data for at least one item purchased by the user through at least one retailer;
store the purchase data in the at least one user database and associate the purchase data with the user profile;
communicate, to a client device of the user, display data configured to generate at least one user interface on the client device comprising a visual representation of at least a portion of the purchase data; and
post the at least a portion of the purchase data and at least one photograph or video to at least one social media platform.

18. The apparatus of claim 17, wherein the program instructions, when executed by the at least one processor, further cause the at least one processor to:
receive, from the client device, a selection of the at least one social media platform; and
in response to receiving the selection from the client device, post the at least a portion of the purchase data.

19. The apparatus of claim 17, wherein the program instructions, when executed by the at least one processor, further cause the at least one processor to:
compare a predetermined product category corresponding to the at least one item to a plurality of approved product categories associated with the user profile; and
in response to determining that the predetermined product category matches an approved product category of the plurality of approved product categories, automatically post the at least a portion of the purchase data.

20. The apparatus of claim 17, wherein the at least one photograph or video comprises at least one of the following received from the at least one product database or the client device: a client-provided photograph or video, a retailer-provided photograph or video, a stock photograph or video, or any combination thereof.
